(19) United States
(12) Patent Application Publication
(10) Pub. No.: US 2012/0305181 A1
(43) Pub. Date: Dec. 6, 2012

(54) POLARIZING PLATE, METHOD FOR FABRICATING SAME, AND IMAGE DISPLAY APPARATUS USING SAME

(76) Inventors: Sung-Hyun Nam, Yuseong-gu (KR); Ki-Ok Kwon, Seo-gu (KR); Kyun-Il Rah, Seo-gu (KR)

(21) Appl. No.: 13/580,624

(22) PCT Filed: Feb. 23, 2011
(86) PCT No.: PCT/KR11/01260

§ 371 Date: Aug. 22, 2012

(30) Foreign Application Priority Data
Feb. 23, 2010 (KR) 10-2010-0016307
Feb. 22, 2011 (KR) 10-2011-0015583

(51) Int. Cl. G02B 5/30; B32B 37/12; G02F 1/1335; H05B 33/00; B82Y 20/00

(52) U.S. Cl. 156/305; 349/96; 359/492.01; 313/504; 977/902

(57) ABSTRACT

Provided are a polarizer, a manufacturing method thereof, and an image display device employing the same. The polarizer includes a polarization element, a first adhesive layer formed on one side of the polarization element, a second adhesive layer formed on the other side of the polarization element, a protective film attached to the first adhesive layer, and an adhesion layer formed under the second adhesive layer.

### TECHNICAL FIELD

The present invention relates to a polarizer for an image display device and a manufacturing method thereof, and more particularly, to a polarizer having a reduced bending phenomenon, and a manufacturing method thereof.

### BACKGROUND ART

In general, a polarizer is formed by bonding a Triacetyl Cellulose (TAC) film to a polarizer as a protective film in which Poly Vinyl Alcohol (hereinafter, referred to as PVA) based molecule chains are oriented in a certain direction and contain an iodine-type compound or dichromatic polarizing substances. Here, the polarizer and the protective film are generally bonded to each other by a water-based adhesive made of a Poly Vinyl Alcohol-based aqueous solution.

Meanwhile, in the case of a liquid crystal display device driven in an In-Plane Switching (IPS) liquid crystal mode, it is known that the color change problem according to the viewing angle can be considerably reduced when using a polarizer to one side of which a protective film is attached and to the other side of which an adhesion layer is attached. Additionally, in this case, since only one sheet of protective film is used, the thickness of the polarizer may be reduced to thereby be advantageously thin and light.

A polarizer having the above-mentioned structure is generally manufactured by carrying out processes of laminating a protective film to one side of a polarizing film by the medium of a water-based adhesive, drying the adhesive to manufacture an intermediate polarizer, coating the other side of the polarizing film with adhesive, and drying the same. However, a polarizer manufactured by such a conventional method has a bending phenomenon even in an intermediate state and the bending phenomenon tends to become serious with the adhesive coating and the drying. The bending phenomenon occurs due to the asymmetrical structure of polarizer and deepens due to differences in adhesion between the adhesives applied to each side of a polarizer.

Meanwhile, in the case of using a polarizer having the bending phenomenon as above, undesirable contact with a liquid crystal panel may easily occur, and in the case that the polarizer is mounted on a display device module, a large amount of stress may be generated, with the same coming into contact with a case to induce light-leakage or a mura phenomenon, causing poor image quality.

### DISCLOSURE

### Technical Problem

An aspect of the present invention provides a polarizer having a reduced bending phenomenon, a manufacturing method thereof, and an image display device employing the same.

### Technical Solution

According to an aspect of the present invention, there is provided a polarizer, including: a polarization element; a first adhesive layer formed on one side of the polarization element; a second adhesive layer formed on the other side of the polarization element; a protective film attached to the first adhesive layer; and an adhesion layer formed under the second adhesive layer.

Here, the first adhesive layer or the second adhesive layer preferably have thicknesses of 20 nm to 100 nm, and more preferably, 50 nm to 300 nm.

In addition, the first adhesive layer or the second adhesive layer may be formed by using an adhesive substance having a preferable viscosity of 4 cP to 50 cP, and the first adhesive layer or the second adhesive layer may preferably be formed by using adhesive substance with a polymerization degree in a range of 500 to 1,800 or a solid content in a range of 2 wt % to about 10 wt %.

Meanwhile, the first adhesive layer and the second adhesive layer may be formed with adhesives of different materials or may be formed with an adhesive of the same material.

According to another aspect of the present invention, there is provided a method for manufacturing a polarizer, including: positioning a protective film on one side of a polarization element, and positioning an adhesion layer on the other side of the polarization element; interposing adhesives respectively between the protective film and the polarizer, and between the adhesion layer and the polarizer; and laminating the protective film and the adhesion layer to the polarizer by the adhesives, and drying the resultant structure.

Here, the drying is preferably carried out at 20° C. to 1000, and more preferably at 40° C. to 90° C.

According to another aspect of the present invention, there is provided an image display device including the polarizer. Here, the image display device may be a liquid crystal display device (LCD) or an organic EL, and if it is a liquid crystal display device, the driving mode may be an In-Plane Switching (IPS) mode, a Twisted Nematic (TN) mode, a Vertically Aligned (VA) mode, or a FFS (Fringe Field Switching) mode.

### Advantageous Effects

A polarizer of the present invention has a light bending phenomenon less than that of the related art, and thus the polarizer has an advantage having high image quality when applied to an image display device. Particularly, if the polarizer of the present invention is applied to a LCD using an IPS mode, the color change problem according to the viewing angle may be significantly reduced.

In addition, since only one sheet of protective film is used, the polarizer may advantageously be formed to be thin and light.

In addition, according to the polarizer of the present invention, an adhesive resin containing a Poly Vinyl Alcohol resin having an acryl group and a hydroxy group may be used as an adhesive to improve the durability and water-resistance of the polarizer.

### DESCRIPTION OF DRAWINGS

The above and other aspects, features and other advantages of the present invention will be more clearly understood from the following detailed description taken in conjunction with the accompanying drawings, in which:

FIG. 1 is a view illustrating the structure of a polarizer for a related art LCD of IPS mode;

FIG. 2 is a view illustrating a polarizer according to an embodiment of the present invention;

FIG. 3 is a view illustrating a polarizer according to another embodiment of the present invention;

FIG. 4 is a view illustrating a method for manufacturing a polarizer according to an embodiment of the present invention;

FIG. 5 is a photograph showing a degree of curling of a polarizer according to Comparative Example 1;

FIG. 6 is a photograph showing a degree of curling of a polarizer according to the embodiment of the present invention;

FIG. 7 is a set of photographs showing water-resistance test results of polarizers according to the Example and Comparative Example 1;

FIG. 8 is a set of photographs showing contrast ratio measurement results of polarizers according to the Example and Comparative Example 2;

FIG. 9 is a graph for comparing the contrast ratios of the polarizers according to the Example and comparative Example 2;

FIG. 10 is a set of photographs showing distribution of reciprocal numbers of black luminance of the polarizers according to the Example, Comparative Example 2, and Comparative Example 3;

FIG. 11 is a graph for comparing the black luminance ratios of the polarizers according to the Example, Comparative Example 2, and Comparative Example 3;

FIG. 12 is a graph showing the viscosity of an adhesive depending on the degree of polymerization of an adhesive resin; and

FIG. 13 is a graph showing the viscosity of an adhesive depending on the solid content of an adhesive resin.

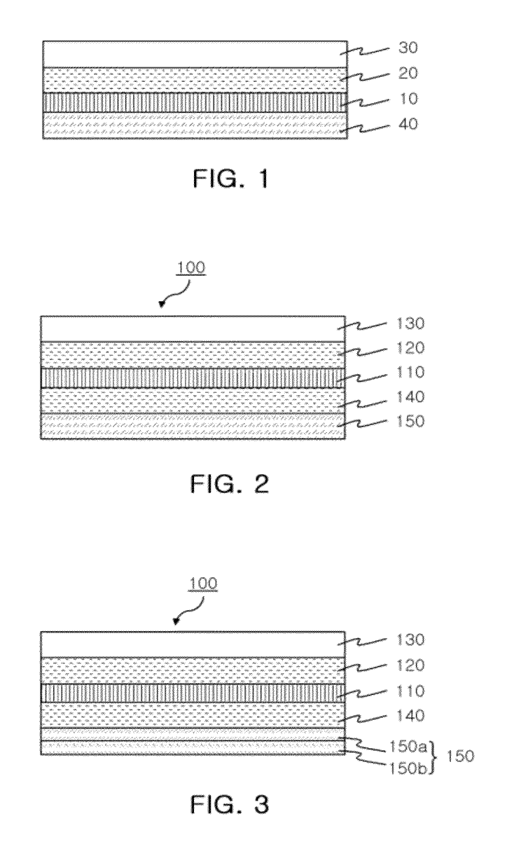

### MODE OF INVENTION

Exemplary embodiments of the present invention will now be described in detail with reference to the accompanying drawings. The accompanying drawings are merely illustrative, however, and the present invention is not limited thereto. In addition, some elements may be exaggerated, simplified, or omitted from the drawings for convenience of description.

FIG. 2 is a schematic view illustrating a structure of a polarizer according to an embodiment of the present invention. As shown in FIG. 2, a polarizer 100 of the present invention includes a polarization element 110, a first adhesive layer 120, a second adhesive layer 140, a protective film 130, and an adhesion layer 150.

The polarizer 110 refers to an optical element allowing only light in a certain polarization state to pass through and thus, a Poly Vinyl Alcohol-based polarizing film, containing an iodine-based compound or a dichromatic dye and in which molecular chains are oriented in a certain direction, is generally used. Such a polarizing film is manufactured by dyeing a Poly Vinyl Alcohol-based film with iodine or a dichromatic dye, stretching the film in a certain direction, and crosslinking the film. Here, the degree of polymerization of the Poly Vinyl Alcohol is not specifically limited. However, when considering free movement of molecules and easy mixture with contained substances, it is preferably 1,000 to 10,000, and more preferably 1,500 to 5,000.

Next, the first adhesive layer 120, for boding the protective film 130 to be described later and the polarization element 110, is formed on one surface of the polarization element 110.

Meanwhile, the second adhesive layer 140, for bonding the polarization element 110 and the adhesion layer 150, is formed on a surface on which the first adhesive layer 120 of the polarization element 110 is not formed.

The first adhesive layer 120 and the second adhesive layer 140 have thicknesses of 20 nm to 1,000 nm, preferably 30 nm to 500 nm, and more preferably, 50 nm to 300 nm. When the thickness of the adhesive layer is less than 20 nm, there would be a problem in durability and adhesive strength, and when the thickness is more than 1,000 nm, there would be a curl.

Meanwhile, materials of the first adhesive layer 120 or the second adhesive layer 140 are adhesive substances having a viscosity in a range of 4 cP to 50 cP, preferably 4 cP to 45 cP, more preferably 4 cP to 40 cP. That is because, when the adhesive has a viscosity of 4 cP to 50 cP, the reduction of the bending phenomenon is maximized. When the viscosity of the adhesive is greater than the above-mentioned range, however, it is difficult to secure a consistent curling property and it also may have adverse effects on the properties of a polarizer, a final product. More specifically, when the viscosity of adhesive is less than 4 cP, since the adhesive easily flows down an inclined surface when manufacturing plates, it is impossible to secure processability. When the viscosity is more than 50 cP, the adhesive becomes thicker and the viscosity and the solid content increase, thereby causing a considerable decrease of the drying efficiency of adhesive moisture. As a result, the adhesive may not be completely dried, and black spots may be present on the surface of a finished polarizer. In addition, due to the incomplete drying, the final polarizer may have non-uniform curling properties.

In addition, the first adhesive layer 120 or the second adhesive layer 140 may preferably be formed with adhesive substances having a degree of polymerization in a range of 500 to 1,800 and a solid content in a range of 2 wt % to 10 wt. That is because when the degree of polymerization and the solid content of the adhesive resin are in an above-mentioned range, proper viscosity may be obtained.

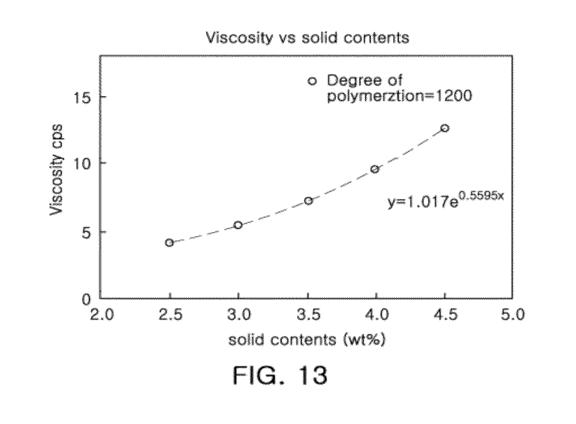

Generally, the more the degree of polymerization of the adhesive resin and the solid content of the adhesive increase, the more the viscosity of the adhesive increases. FIG. 12 is a graph showing the viscosity of adhesives according to the degree of polymerization of the adhesive resin, while FIG. 13 is a graph showing the viscosity of adhesives according to the change in solid content when the degrees of polymerization are identical. Through FIGS. 12 and 13, it can be seen that an adhesive substance having a viscosity in a range of 4 cP to 50 cP may be secured when the degree of polymerization is 500 to 1,800 and the solid content is 2 wt % to 10 wt %.

In addition, the first adhesive layer 120 and the second adhesive layer 140 may be formed with adhesive resins having different materials or they may be formed with adhesive resins having the same materials. When adhesive layers formed of the same materials are formed on each side of the polarizer 110, the forces applied to the polarizer 110 by both adhesive layers are identical, and thus, the occurrence of the bending phenomenon is considerably reduced.

The adhesive resin forming the first adhesive layer 120 and the second adhesive layer 140 is not specifically limited, as long as it has excellent optical transmittance and no change such as yellowing over time. For example, in the present invention, the first adhesive layer 20 may be formed with an adhesive resin including a Poly Vinyl Alcohol-based resin, an Acryl-based resin, a Vinyl Acetate-based resin or a UV-curable resin, and the above-mentioned adhesive resins may be water-based adhesives or non-solvent-type adhesives.

In the case of the adhesive resin forming the adhesive layers of the present invention, water-based adhesives, particularly including a Poly Vinyl Alcohol-based resin, may be used, and an adhesive resin, including a Poly Vinyl Alcohol-based resin, (hereinafter, referred to as AH-PVA resin) having an acryl group and a hydroxyl group or adhesive resin including a Poly Vinyl Alcohol-based resin and a compound having an acryl group and an epoxy group may be used. An adhesive resin including AH-PVA resin or a Poly Vinyl Alcohol-based resin and a compound having an acryl group and an epoxy group has better adhesive strength, water-resistance, and moisture-resistance than other adhesives in the related art, as well as the fact that the resin has excellent water solubility.

More specifically, AH-PVA resin used in the present invention may be formed by including a repeating unit represented by the following chemical formula 1a and a repeating unit represented by the following chemical formula 1b, and a repeating unit represented by the following chemical formula 1c may selectively be added.

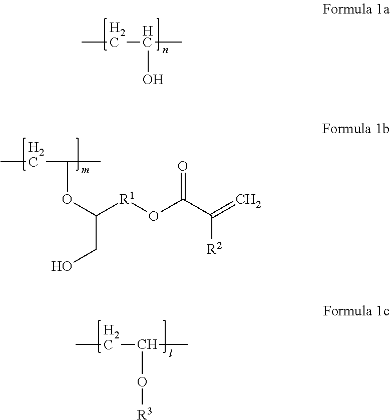

Here, in the above-mentioned formulas, R¹ may be substituted or unsubstituted C₁-C₂₀ alkandiyl; a substituted or unsubstituted 1 to 7-membered cyclic compound; a substituted or unsubstituted 1 to 7-membered hetero cyclic compound including hetero atoms selected from the group consisting of N, S, and O; a substituted or unsubstituted C₆-C₁₄ aromatic compound; or a substituted or unsubstituted 1 to 7-membered hetero aromatic compound including hetero atoms selected from the group consisting of N, S, and O,

R² may be a substituted or unsubstituted C₁-C₂₀ alkyl group; a substituted or unsubstituted 1 to 7-membered cyclic compound; a substituted or unsubstituted 1 to 7-membered hetero cyclic compound comprising hetero atoms selected from the group consisting of N, S, and O; a substituted or unsubstituted C₆-C₁₄ aromatic compound; or a substituted or unsubstituted 1 to 7-membered hetero aromatic compound including hetero atoms selected from the group consisting of N, S, and O.

When the R¹ and R² are substituted with a substituent, the substituent may be a C₁ to C₂₀ alkyl group or a halogen atom selected from the group consisting of F, Cl, Br, and I, and R³ may be an acetoacetyl group, a carboxylic acid group, an acryl group, or a urethane group.

Meanwhile, when AH-PVA resin includes a repeating unit represented by the following chemical formula 1a and a repeating unit represented by the following chemical formula 1b, it is preferable that the above mentioned n is an integer of 480 to 1,700, n is an integer of 10 to 900, and n+m is an integer of 500 to 1,800. When the above-mentioned AH-PVA resin includes a repeating unit represented by the following chemical formula 1a, a repeating unit represented by the following chemical formula 1b, and a repeating unit represented by the following chemical formula 1c, it is preferable that, in the above-mentioned Chemical Formulas, n is an integer of 480 to 1,700, m is an integer of 10 to 900, 1 is an integer of 1 to 80, n+m is an integer of 500 to 1,800, n+1 is an integer of 490 to 1,700, and n+m+1 is an integer of 500 to 1,800.

Meanwhile, the repeating units represented by the above-mentioned Chemical Formulas 1a, 1b, and 1c may randomly be arranged in AH-PVA resin polymer.

Meanwhile, the above-mentioned AH-PVA resin contains an acryl group of 0.1˜50 mol % of PVA resin, preferably 0.1˜20 mol %, and more preferably, 0.1˜10 mol %. In PVA resin, an acryl group content of less than 0.1 mol % is undesirable because there is no effect of improving adhesive strength, moisture-resistance, and water-resistance by the introduction of an acryl group, and when the acryl group content is more than 50 mol %, water solubility decreases and the adhesive strength decreases too.

The AH-PVA resin is obtained by modifying a Poly Vinyl Alcohol-based resin into compound having an epoxy group and an acryl group. Here, as a compound having an epoxy group and an acryl group, the compound of the following chemical formula 3 may be used. In chemical formula 3, R¹ and R² are same as defined above.

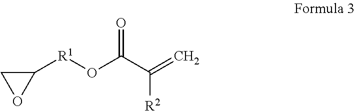

More specifically, the AH-PVA resin of the present invention may be manufactured by the following reaction

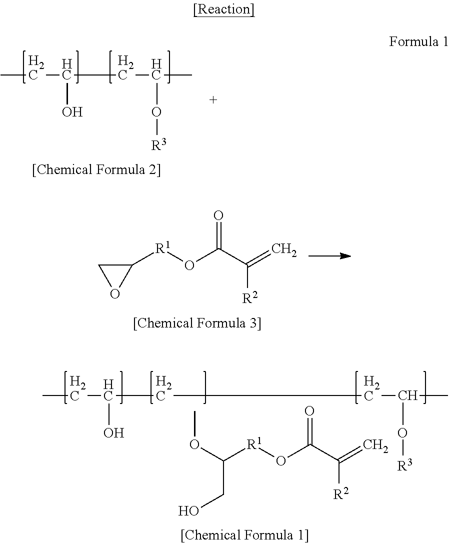

The above-mentioned reaction formula 1 is a reaction formula showing a conventional process of changing a Poly Vinyl Alcohol-based resin into AH-PVA resin and the number of repeating units is not stated. In the reaction formula 1, chemical formula 2 is a Poly Vinyl Alcohol-based resin and the Poly Vinyl Alcohol-based resin used in the present invention is not specifically limited, but may be any Poly Vinyl Alcohol-based resin known as an adhesive conventionally used for bonding a polarizer and a protective film in this art, for example, a non-modified Poly Vinyl Alcohol resin or a Poly Vinyl alcohol resin modified with at least one group selected from the group consisting of an acetoacetyl group, a carboxylic acid group, an acryl group, and a urethane group may be used. In a case in which a non-modified Poly Vinyl Alcohol resin is used as a Poly Vinyl Alcohol-based resin, the repeating unit 1c may not be present in the above-mentioned chemical formula 2.

As shown in the reaction formula 1, in the reaction of Poly Vinyl Alcohol (hereinafter, referred to as PVA) of chemical formula 2 and a compound having an epoxy group and an acryl group of chemical formula 3, an acryl group is introduced into PVA resin and at the same time a hydroxyl group (—OH) is formed by the reaction of an OH group or R³ group of the PVA resin and an epoxy group.

Specifically, as indicated in reaction formula 1, when PVA resin (chemical formula 2) and a compound having an epoxy group and an acryl group (chemical formula 3) are dissolved in water to make them react with each other at 25 to 70° C. for 10 to 30 hours, a PVA-based resin (chemical formula 1) in which an acryl group is introduced, and at the same time an —OH group is formed, can be obtained. That is, PVA resin into whose backbone an acryl group is introduced and to form —OH is obtained by the above-mentioned reaction, and such a PVA-based resin into whose backbone an acryl group is introduced to form —OH has excellent water solubility, as well as excellent adhesion, water-resistance, and moisture-resistance properties.

Meanwhile, it is preferable that the AH-PVA resin has a degree of copolymerization of 500 to 1,800. When the degree of copolymerization is less than 500, when manufacturing adhesive, the viscosity is low in the low solid content, so a great quantity of solids should be added, and when the resin exceeds 1,800, the viscosity is high when manufacturing an adhesive, a small quantity of a solid (PVA resin) should be added and this may cause a decrease in adhesive strength. This is undesirable.

Meanwhile, as a material for forming the first adhesive layer or the second adhesive layer of the present invention, an adhesive resin including a Poly Vinyl Alcohol-based resin and a compound having an epoxy group and an acryl group may be used instead of the above-mentioned AH-PVA resin.

Referring to the above-mentioned adhesive resin, it is preferable that the content of a compound having an epoxy group and acryl group is 0.001 to 10 parts by weight per 100 parts by weight of a Poly Vinyl Alcohol-based resin, and more preferably 0.001 to 1 part by weight.

Meanwhile, a Poly Vinyl Alcohol-based resin used for an adhesive resin including Poly Vinyl Alcohol resin and a compound having an epoxy group and an acryl group is not specifically limited, but any Poly Vinyl Alcohol-based resin known in the related art, for example, a non-modified Poly Vinyl Alcohol resin or Poly Vinyl alcohol resin modified with at least one group selected from the group consisting of an acetoacetyl group, a carboxylic acid group, an acryl group, and a urethane group may be used.

Here, it is preferable that the Poly Vinyl Alcohol-based resin has a degree of polymerization of 500 to 1,800. When the degree of polymerization is less than 500, when manufacturing the adhesive, the viscosity is low in the low solid content, so a great quantity of solid (PVA resin) should be added, and when the viscosity exceeds 1,800, the viscosity is high when manufacturing the adhesive, a small quantity of a solid (PVA resin) should be added and this causes decrease of adhesive strength. This is undesirable.

As the compound having an epoxy group and an acryl group, the compound of the above-mentioned chemical formula 3 may be used. When the content of the compound having an epoxy group and an acryl group is less than 0.001 part by weight, there is no effect of improving adhesive strength, moisture-resistance, and water-resistance by the introduction of an acryl group and when the content is more than 10 parts by weight, water solubility decreases, so it is impossible to obtain a uniform adhesive for a polarizer and the solution stability and the adhesive strength decrease. Therefore, it is undesirable.

Meanwhile, to the adhesive resin used in the present invention, a curing initiator may be added if necessary. As a curing initiator, an AIBN (2,2′-azo-bis(isobutyronitrile))-type initiator, a persulphate-type initiator, and an initiator of the Darocure or Igacure series of the Ciba-Geigy company may be used. As the above-mentioned AIBN and persulphate-type initiator, any initiator known in this art as an initiator able to be used with water may be used. Although it is not limited to the following, for example, as the AIBN-type initiator, 2,2′-azobis[2-(2-imidazoline-2-yl)propane]dihydrochloride, 2,2′-azobis[2-(2-imidazoline-2-yl)propane]disulfate dehydrate, 2,2′-azobis[N-(2-carboxyethyl)-2-methylpropionamide], 2,2′-azobis[2-(3,4,5,6-tetrahydropyrimidine-2-yl)propane]dihydrochloride, 2,2′-azobis{2-[1-(2-hydroxyethyl)-2-yl]propane}dihydrochloride, 2,2′-azobis{2-methyl-N-[2-(hydroxybutyl)]propionamide}, 2,2′-azobis[2-methyl-N-[2-(hydroxyethyl)pripionamide], 2,2′-azobis(N-butyl-2-methylpropionamide), and the like may be used, and as the persulphate-type curing initiator, potassium persulphate, ammonium persulphate, and the like. may be used. As initiators of the Ciba-Geigy company, although not limited to the following, for example, hydroxyl-1-[4-(hydroxyethoxy)phenol]-2-methyl-1-propanone (Darocure 2959), 2-hydroxy-2-methyl-1-phenylpropane-1-one (Darocure 1173), 1-(4-isopropylphenyl)-2-hydroxy-2-methylpropane-1-one (Darcure 1116), a 25:75 blend of bis-(2,6-dimethoxybenzoyl)-2,4,4-trimethylpentyl phosphine oxide and 2-hydroxy-2-methyl-1-phenylpropane-1-one (brand name Irgacure 1700), 1-[4-(2-hydroxyethoxy)-phenyl]-2-hydroxy-di-2methyl-1-propane-1-one (Irgacure 2959), 1-hydroxycyclohexylphenylketone (Irgacure 184), 2,2′-dimethoxy-2-phenylacetophenone (Irgacure 651), and the like may be used.

A maximum 10 wt % of the curing initiator to the overall weight of the adhesive resin may be added. The curing initiator is an ingredient arbitrarily added when necessary. Though the lowest amount of the additive content is not limited, to the entire weight of adhesive, preferably 0.01-10 wt %, more preferably 0.01-1 wt % of the curing initiator may be added. When the additive content of the curing initiator is less than 0.01 wt %, the effect from adding the curing initiator is not sufficient, and when the content exceeds 10 wt %, the additive remained after reaction may have adverse effects on the adhesive strength. This is undesirable.

Besides, various coupling agents, tackifiers, UV-absorbers, antioxidents, and various stabilizers may be mixed with the adhesive resin when necessary.

Next, the protective film 130 is a film for protecting the polarizer 110 and is attached to the upper portion of the first adhesive layer 130. For the protective film 130, any polymer films having excellent optical transparency, mechanical strength, thermal stability, isotropy, adhesion with PVA polarizer, etc. may be used. Though it is not limited to the following, as an example of a protective film, a film made of polyester-type polymers such as polyethylene terephthalate, polyethylene naphthalate, styrene-type polymers such as polystyrene and copolymer of acrylonitril and styrene, cellulose-type polymers such as diacetyl cellulose and triacetyl cellulose, polyethersulfone-type polymers, polycarbonate-type polymers or acryl-type polymers such as polymethylmethacrylate, polyolefin-type polymers such as polyethylene, polypropylene, copolymer of ethylene and propylene, amide-type polymers such as nylon or aromatic polyamide, imide-type polymers, sulfone-type polymers, poly ether sulfone-type polymers, polyether ether ketone-type polymers, polyphenylene sulfide-type polymers, vinyl alcohol-type polymers, vinylidene chloride-type polymers, vinyl butyral-type polymers, arylate-type polymers, polyoxy methylene-type polymers, epoxy-type polymers, or mixtures thereof may be used.

Specifically, cellulose-type films such as cellulose esther, triacetyl cellulose film (TAC film), cellulose propionate, cellulose acetate propionate, cellulose diacetate, cellulose acetate butylate film, etc., polycarbonate-type films (PC film), polystyrene-type films, polyarylate-type film, norbornene resin-type films, and polysulfone-type films are desirable because they have transparency and mechanical properties and do not have optical anisotropy. Since triacetyl cellulose film (TAC film) and carbonate film (PC film) are easily formed into layers and have excellent processability, these are desirable, and because of the polarizing property or durability, TAC film is the most desirable.

The protective film may receive a treatment for surface modification to improve its adhesive strength and contact intensity with the polarizer to which the protective film is attached. As specific examples, though not limited to the following, a corona treatment, a glow discharge treatment, a flame treatment, an acid treatment, an alkali treatment, a plasma treatment, an ultrasonic treatment, and an ultraviolet irradiation treatment may be used. In addition, an undercoat layer may be provided to the protective film to improve the adhesion properties thereof.

Meanwhile, the adhesion layer 150 is provided to attach the polarizer 100 to the panel of the image display device formed on the lower portion of the second adhesive layer 10. For the adhesion layer 150, for example, an acryl-type copolymer or epoxy resin, polyurethane resin, silicon resin, polyether resin, polyamide resin, poly vinyl alcohol resin, and the like may be used independently or in a mixture, and among these, an acryl-type copolymer is particularly desirable when considering transparency, weatherability, durability, and adhesive properties.

Meanwhile, the adhesion layer 150 may have one layer as shown in FIG. 2, but also have a first adhesion layer 150a and a second adhesion layer 150b having different moduli from each other as shown in FIG. 3. Here, a modulus, which is an index indicating the elasticity properties of a certain material, is defined by the proportional coefficient between the stress and the deformation rate at a certain areal position and time in the material. That is, in case of simple tension, when the stress is σ, the deformation rate is ε, and the modulus is E, σ can be defined by E·ε, that is, σ=E·ε.

In a case in which the adhesion layer is formed to have 2 layers, if the modulus of the first adhesion layer is determined larger than that of the second adhesion layer, the protective function of the PVA polarizer can be more improved. That is to say, a function protecting the PVA polarizer from external environmental factors deteriorating the polarizing function of the PVA polarizer such as heat, moisture may be given. In addition, chemical functional groups may be added to the adhesive forming the first adhesion layer to improve the adhesive strength to the PVA polarizer and water-resistance.

Meanwhile, here, the modulus of the first adhesion layer is 1˜500 MPa, preferably 50˜450 MPa, and more preferably 100˜400 Mpa and the modulus of the second adhesion layer is 0.01˜0.5 MPa, preferably 0.01˜0.45 MPa, and more preferably 0.01˜0.4 MPa.

In a case in which the adhesion layer is formed with 2 layers having different moduli from each other as shown in FIG. 3, it is desirable to attach an adhesion layer having a higher modulus value to the second adhesive layer. That is because the adhesion layer having high modulus value can more effectively protect the PVA polarizer from external environmental factors such as heat and moisture, and also, the adhesive strength with the PVA polarizer is improved and the water-resistance of the polarizer can be improved by improving the wetting properties of the second adhesive layer. Meanwhile, it is desirable to use the adhesion layer having a low modulus value for adhesion to the glass substrate.

Next, a method for manufacturing a polarizer of the present invention as above-mentioned is described.

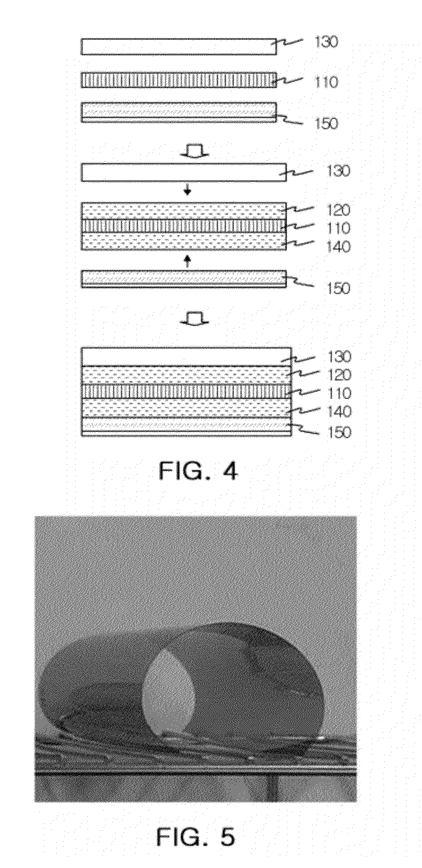

FIG. 4 is a view illustrating a method for manufacturing a polarizer of the present invention. As shown in FIG. 4, the method for manufacturing a polarizer of the present invention includes the steps of (i) positioning a protective film on one side of a polarization element and positioning an adhesion layer on the other side of the polarization element, (ii) respectively interposing adhesives between the protective film and the polarizer, and between the adhesion layer and the polarizer, and (iii) laminating the protective film and the adhesion layer to the polarizer by the adhesives, and drying the resultant structure.

First, the protective film 130 and the adhesion layer 150 are positioned respectively on both sides of the polarization element. Here, as mentioned above, it is desirable that the polarizer 110 is a PVA polarizing film containing an iodine-type compound or a dichromatic dye and where molecule chains are oriented in a certain direction and it is desirable that the degree of polymerization of the Poly Vinyl Alcohol is 1,000 to 10,000, more preferably 1,500 to 5,000.

In addition, for the protective film 130, a film made of polyester-type polymers such as polyethylene terephthalate, polyethylene naphthalate, styrene-type polymers such as polystyrene and copolymer of acrylonitril and styrene, cellulose-type polymers such as diacetyl cellulose and triacetyl cellulose, polyethersulfone-type polymers, polycarbonate-type polymers or acryl-type polymers such as polymethylmethacrylate, polyolefin-type polymers such as polyethylene, polypropylene, a copolymer of ethylene and propylene, amide-type polymers such as nylon or aromatic polyamide, imide-type polymers, sulfone-type polymers, poly ether sulfone-type polymers, polyether ether ketone-type polymers, polyphenylene sulfide-type polymers, vinyl alcohol-type polymers, vinylidene chloride-type polymers, vinyl butyral-type polymers, arylate-type polymers, polyoxy methylene-type polymers, epoxy-type polymers, or mixtures thereof may be used.

Meanwhile, for the adhesion layer 150, any material optically transparent and having a proper viscoelasticity or adhesive property may be used and it is not limited to a specific material. For example, for the adhesion layer 150, an acryl-type copolymer or epoxy resin, polyurethane resin, silicon resin, polyether resin, polyamide resin, poly vinyl alcohol resin, and the like may be used alone or in a mixture thereof, and acryl-type copolymer among these is particularly desirable when considering transparency, weatherability, durability, and adhesive property.

Here, for the adhesion layer 150, an adhesion sheet formed by coating an adhesive on a release film may be used. Here, the adhesion sheet may be manufactured by applying adhesive resin to a release film and then hardening the same through methods such as drying, thermal curing, chemical curing, thermal melting, or photo-curing.

In addition, the adhesion layer 150, as mentioned above, may be formed with the first adhesion layer 150a and the second adhesion layer 150b having different moduli from each other. Here, the modulus of the first adhesion layer is 1˜500 MPa, preferably 50˜450 MPa, and more preferably 100˜400 Mpa and the modulus of the second adhesion layer is 0.01˜0.5 MPa, preferably 0.01˜0.45 MPa, and more preferably 0.01˜0.4 MPa.

Next, adhesives are respectively interposed between the protective film and the polarization element, and between the adhesion layer and the polarization element. Here, the adhesive interposed between the protective film and the polarization element and the adhesive between the adhesion layer and the polarization element may be made of the same or different materials, and it is preferable that the adhesive layer has a thickness of 20 nm to 1,000 nm.

This step, as shown in FIG. 4, may be formed by applying adhesive on both sides of the polarizer or applying adhesive on one of the of the protective film and the adhesion layer sides facing the polarizer respectively.

Meanwhile, for the adhesive, one having adhesive strength possible to bond the polarizer and the protective layer or the polarizer and the adhesion layer, an excellent optical transmittance, and without yellowing with time may be used, however, there is no special limit. For example, an adhesive comprising one or more selected from the group consisting of a Poly Vinyl Alcohol-based resin, an Acryl-based resin, a Vinyl Acetate-based resin and UV-curable resin may be used, preferably an adhesive including a Poly Vinyl Alcohol-based resin, and more preferably an adhesive including a Poly Vinyl Alcohol-based resin containing an acryl group and a hydroxyl group may be used.

After having interposed adhesive through the above-mentioned process, the protective film and the adhesion layer are laminated to the polarizer by the adhesive and dried. Here, the laminations may be carried out one by one or at the same time, but laminations at the same time are more desirable in consideration of production efficiency.

Here, the drying temperature, though it differs depending on used adhesives, is generally 20° C. to 100° C., and more preferably 40° C. to 90° C.

In addition, in a case in which there exist foreign materials in lamination and drying, the lamination cannot be smoothly carried out. Therefore, it is desirable that this process be carried out in an environment in which there are few floating foreign materials or a process for removing foreign materials should be carried out before the laminating process. For a method of removing foreign materials, a process not having adverse effects on the polarizer, the protective film, and the adhesion may be used and there is no special limit thereon. To remove foreign materials, for example, a method of adding a washing process in the polarizer manufacturing process to wash foreign materials from the surface of the film in a washing bath filled with water, a method of inclining the film in its progressing direction in the process and making water flow down on the inclined surface, a method of removing water remaining on the surface of the film after washing by injecting compressed gas such as oxygen or nitrogen, or a method of blowing foreign materials to remove them by directly injecting compressed gas may be used.

Meanwhile, for a smooth lamination process, it is preferable that the amount of foreign materials be less than 1 g/m² per unit area and it is more preferable that the amount is less than 0.5 g/m². Here, the amount of foreign materials means the weight of foreign materials per unit area.

Through the above-mentioned method, a polarizer having a structure in which, from the top, the protective film-the first adhesive layer-the polarizer-the second adhesive layer-the adhesion layer are arranged in this order. The polarizer of the present invention having such a structure has a bending phenomenon which is considerably reduced in comparison with the conventional polarizer, and even after having laminated the plate to the image display device, the entire of the bent plates is reduced. Therefore, in the case of using the polarizer of the present invention, there is an advantage that the deterioration of image quality decreases in comparison with the case of using the conventional one.

In addition, when the first or the second adhesive layers are formed with an adhesive resin including AH-PVA resin or PVA resin and a compound containing an acryl group and an epoxy group, an effect in which the adhesive strength of the polarizer, the moisture-resistance, and the water-resistance properties are improved can be obtained.

Meanwhile, the polarizer of the present invention may be used for an image display device, for example, as a polarizer for a liquid crystal display device, a polarizer for an anti-reflection for an organic electroluminescence (EL). Here, the above-mentioned liquid crystal display device can be used in all kinds of driving modes, for example, various driving modes such as an In-Plane Switching (IPS) mode, a Twisted Nematic (TN) mode, a Vertically Aligned (VA) mode, or a FFS (Fringe Field Switching) mode.

Hereinafter, the present invention will be described in detail through specific embodiments. It is clear that the scope of the present invention is not limited to the following embodiments.

### EXAMPLE 1

A polarizer was obtained by passing Poly Vinyl Alcohol (PVA) film (manufactured by Kuraray Co. Ltd., degree of polymerization: 2400) through a washing tank and a swelling tank, dyeing the polarizer in an aqueous solution containing I₂ and KI, and then stretching the polarizer in an aqueous solution containing boric acid and KI until the film was quintupled.

Then, a triacetylcellulose (TAC) film having 60 μm of thickness was positioned on one side of the polarizer and an adhesive film protected by PE release film was positioned on the other side the polarizer. Here, the adhesive film was composed of 2 adhesion layers respectively having 270 MPa and 0.02 MPa of modulus values.

Then, aqueous solution of a PVA-type adhesive was interposed between the polarizer and the TAC film and between the polarizer and the adhesive film from which the PE release film is removed, and they were laminated by a laminator and dried at 80° C. for 8 minutes to manufacture a polarizer.

### COMPARATIVE EXAMPLE 1

A polarizer was obtained by passing Poly Vinyl Alcohol (PVA) film (manufactured by Kuraray Co. Ltd., polymerization degree: 2400) through a washing tank and a swelling tank, dyeing the polarizer in an aqueous solution containing I₂ and KI, and then stretching the polarizer in an aqueous solution containing boric acid and KI until the film is quintupled.

Then, a triacetylcellulose (TAC) film was positioned on only one side of the polarizer, an aqueous solution of a PVA-based adhesive was interposed in between, and the films were laminated by the laminater and dried at 80° C. for 8 minutes to manufacture a polarizer, on only one side of which the triacetylcellulose (TAC) film was laminated. Then, on the other side of the polarizer where the triacetylcellulose (TAC) film was not laminated, an adhesive film from which the release film was removed was laminated by the laminator to manufacture the final polarizer. Here, the adhesive film was composed of 2 adhesion layers respectively having 270 MPa and 0.02 MPa of modulus values.

### COMPARATIVE EXAMPLE 2

A polarizer was obtained by passing Poly Vinyl Alcohol (PVA) film (manufactured by Kuraray Co. Ltd., polymerization degree: 2400) through a washing tank and a swelling tank, dyeing the polarizer in an aqueous solution containing I₂ and KI, and then stretching the polarizer in an aqueous solution containing boric acid and KI until the film was quintupled.

Then, a triacetylcellulose (TAC) film having 60 μm of thickness was positioned on both sides of the polarizer, an aqueous solution of a PVA-type adhesive was interposed between the polarizer and the TAC film, and the films were laminated by the laminator and dried at 80° C. for 8 minutes to manufacture a polarizer. Then, to the triacetylcellulose (TAC) film on one side of the polarizer, the corona treatment was applied, an adhesive film from which the PE release film was removed was laminated by the laminator to manufacture the final polarizer. Here, the adhesive film was composed of one adhesion layer having 0.01 MPa of modulus value.

### COMPARATIVE EXAMPLE 3

A polarizer was obtained by passing Poly Vinyl Alcohol (PVA) film (manufactured by Kuraray Co. Ltd., polymerization degree: 2400) through a washing tank and a swelling tank, dyeing the polarizer in an aqueous solution containing I₂ and KI, and then stretching the polarizer in an aqueous solution containing boric acid and KI until the film was quintupled.

Then, a triacetylcellulose (TAC) film was positioned on only one side of the polarizer, an aqueous solution of a PVA-type adhesive is interposed in between, and then they are laminated by the laminator and dried at 80° C. for 8 minutes to manufacture a polarizer only one side of which the triacetylcellulose (TAC) film is laminated. Then, on the other side of the polarizer where the triacetylcellulose (TAC) film is not laminated, an adhesive film from which the release film is removed is laminated by the laminator to manufacture the final polarizer. Here, the adhesive film is composed of one adhesion layer having 0.01 MPa of modulus value.

### EXPERIMENTAL EXAMPLE 1

### Assessment of Curl Occurrence

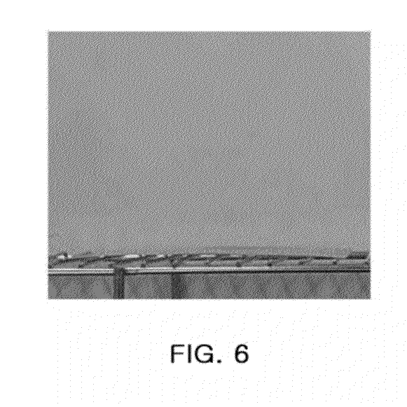

The degree of curl occurrence in the polarizer samples manufactured according to the Example and Comparative Example 1 was measured with the naked eye. FIG. 5 is a photograph showing the polarizer manufactured according to Comparative Example 1 and FIG. 6 is a photograph showing the polarizer manufactured according to the Example.

As shown in FIGS. 5 and 6, the polarizer sample of Comparative Example 1 has a serious degree of curl occurrence while the polarizer sample of Example has small degree of curl occurrence.

### EXPERIMENTAL EXAMPLE 2

### Assessment of Water-Resistance

The assessment of water-resistance was performed by cutting a 5 cm wide and 5 cm long piece of the polarizer manufactured according to the Example and Comparative Example 1, laminating the polarizer on a glass substrate having 1.1 mm of thickness, and then immersing the polarizer in a water tank at 60° C.

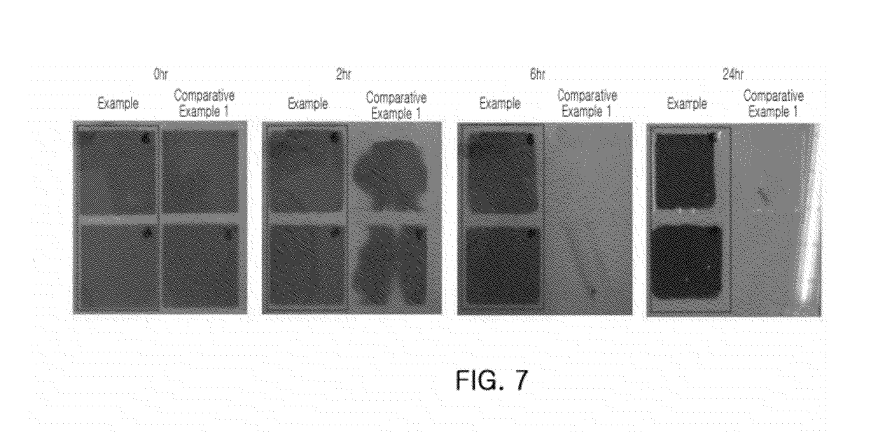

FIG. 7 is a set of photographs showing the degree of peeling with time of the polarizers of the Example and Comparative Example 1. As shown in FIG. 7, the polarizer sample of Comparative Example 1 completely peels off while the polarizer sample of Example has relatively low degree of peeling.

### EXPERIMENTAL EXAMPLE 3

### Assessment of Constrast Ratio

The contrast ratio (CR) was measured after mounting the polarizers manufactured according to the Example and Comparative Example 2 on an image display device of Twisted Nematic mode. The contrast ratio (hereinafter, referred to as CR) is contrast ratio of an image display device indicating the definition of screen. As the CR is high, the optical performance of an image display device is excellent.

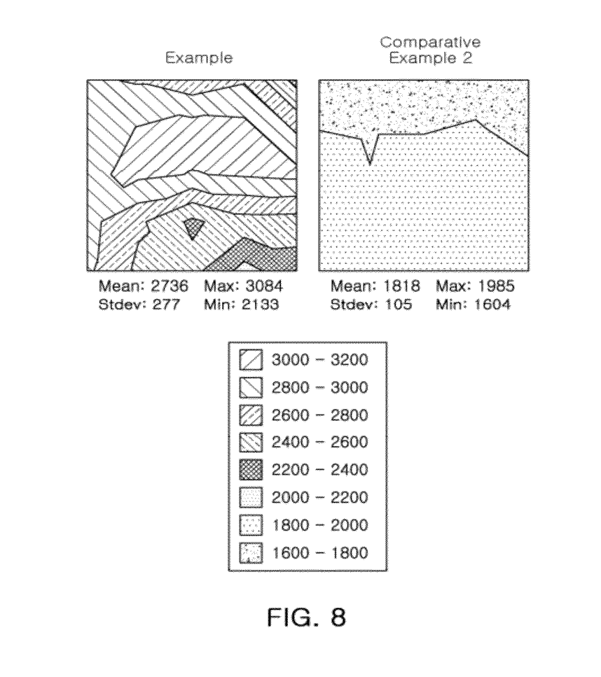

FIG. 8 shows the contrast ratios when the polarizers manufactured according to the Example and Comparative Example 2 were mounted. As shown in FIG. 8, the contrast ratio when mounting the polarizer according to the Example is better than that when mounting the polarizer according to Comparative Example 2.

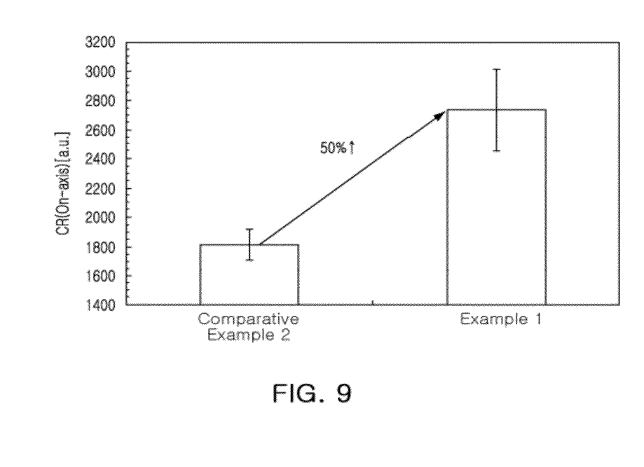

FIG. 9 is a graph of the contrast ratios measured when the polarizer of the Example and the polarizer of Comparative Example 2 were mounted. As shown in FIG. 9, the CR of the polarizer according to Example increased by 50% in comparison with that of the polarizer according to Comparative Example 2.

### EXPERIMENTAL EXAMPLE 4

### Assessment of Black Luminance

After having mounted the polarizers manufactured according to the Example, Comparative Example 2, and Comparative Example 3 on an image display device of the In-Plane Switching (IPS) mode, the distribution of reciprocal numbers of black luminance L_{b}, that is, the distribution of L_{b}⁻¹ was measured.

Generally, the CR is expressed by the ratio of the white luminance L_{w} and the black luminance L_{b} realized by an image display device, that is, L_{w}/L_{b}, and the CR may be expressed by 1/L_{b}, that is, L_{b}⁻¹ value considering only L_{b} sensitively reacting to the optical property of a polarizer. Accordingly, an increase of the L_{b}⁻¹ value indicates that the CR of an image display device increased.

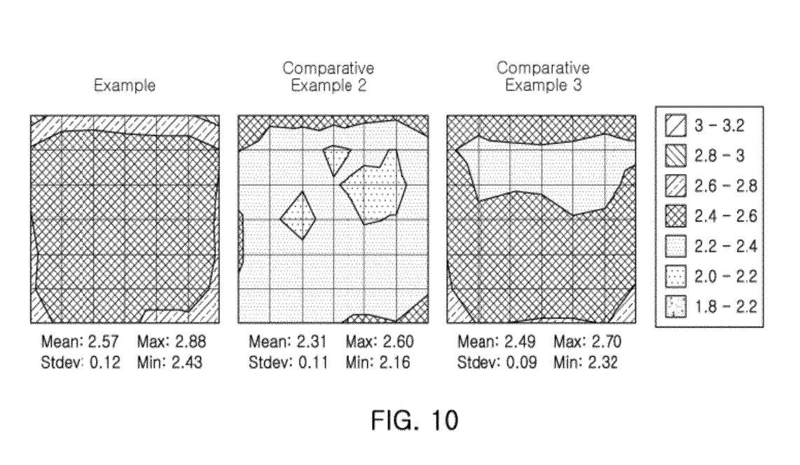

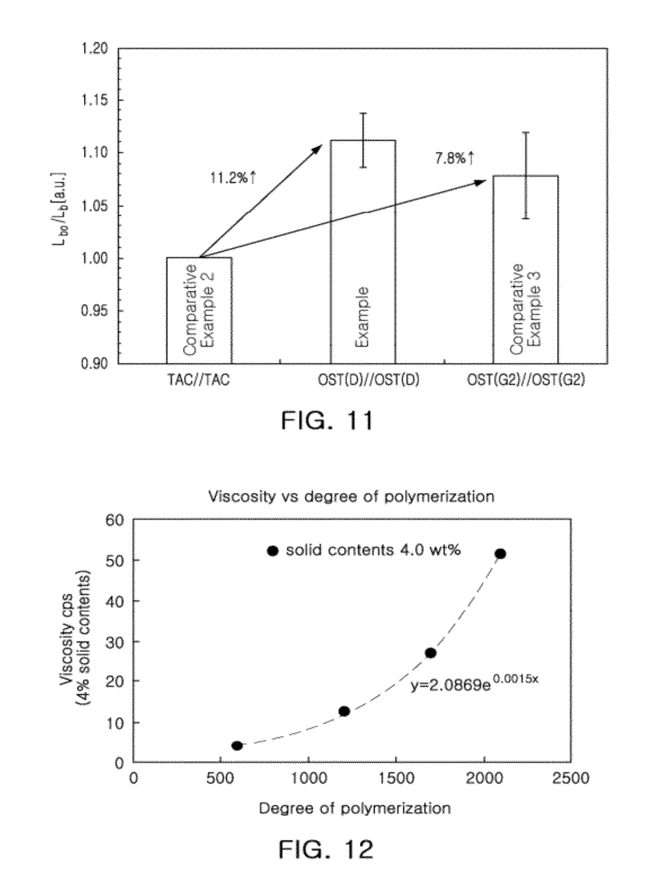

FIG. 10 is a set of photographs showing the distribution of L_{b}⁻¹ in a case in which the polarizers manufactured according to the Example, Comparative Example 2, and Comparative Example 3 are mounted on an image display device of the In-Plane Switching (IPS) mode, and FIG. 11 is a graph showing ratios L_{b0}/L_{b} of the measured black luminance values to the L_{b}⁻¹ values when mounting the polarizer according to Comparative Example 2.

As shown in FIGS. 10 and 11, L_{b}⁻¹, when using the polarizer of the example for comparison 3, increased only by 7.8% in comparison with the case of using the polarizer of Comparative Example 2, while L_{b}⁻¹, when using the polarizer according to Example, increases by 11.2%. This means the optical properties are more improved.

### EXPERIMENTAL EXAMPLE 4

### Assessment of Polarizer Property in Response to the Viscosity of Adhesive Resin

To assess the polarizer property in response to the viscosity of the adhesive resin, a polarizer having a same structure as that of Example was manufactured by using adhesive resin composites having viscosities shown in the following [Table 1] and the solubility, drying efficiency, processability, and the orthogonal transmittance rate are measured.

Solubility is measured by observing the mixture degree of the adhesive resin and the solvent with the naked eye. When the adhesive resin and the solvent are completely mixed so as to be homogeneous, it is expressed by O, and when the phase separation between the adhesive resin and the solvent is observed, it is expressed by X.

The processability indicates the degree that the adhesive flows down when applying the adhesive. When the operation is impossible because the adhesive flows down, it is expressed as X.

The drying efficiency is measured by observing black spots due to incomplete drying on the surface of the polarizer after 10 minutes of drying.

T_{c}/T_{c.s} is a value indicating relative rate of the orthogonal transmittance ratio (Tc.s) of the polarizer manufactured by using adhesive resins having various viscosities except 12.7 cP, taking the orthogonal transmittance ratio (Tc) of the polarizer manufactured by using an adhesive resin having 12.7 cP of viscosity as a standard. When the Tc/Tc.s value is more than 1, this means that the optical property is not good in comparison with that of Example, and when this value is lower than 1, this means that the optical property is excellent in comparison with that of Example.

TABLE 1
Ratio of orthogonal property of polarizer according
to the viscosity of adhesive

| | | Drying | Processability | |
|---|---|---|---|---|
| Viscosity | | efficiency | (degree of | |
| (cps) | Solubility | (black spots) | flow) | Tc/Tc · s |
| 1.5 | ◯ | — | X | 1.02 |
| 2.4 | ◯ | — | X | 1.08 |
| 5.3 | ◯ | — | ◯ | 1.12 |
| 12.8 | ◯ | — | ◯ | 0.98 |
| 27.0 | ◯ | — | ◯ | 0.97 |
| 51.5 | Δ | Spots | ◯ | 1.80 |
| 4.1 | ◯ | — | ◯ | 1.10 |
| 5.4 | ◯ | — | ◯ | 1.06 |
| 12.7 | ◯ | — | ◯ | 1.00 |
| 273.7 | X | Spots | ◯ | 1.65 |
| 29.2 | ◯ | — | ◯ | 1.11 |
| 16.1 | ◯ | — | ◯ | 1.05 |
| 65.1 | Δ | Spots | ◯ | 1.59 |
| 74.6 | ◯ | — | ◯ | 0.95 |

Through the above [Table 1], it can be verified that when using adhesives having viscosities of 51.5˜273.7 Cp, the drying efficiency of the moisture in adhesive is considerably decreased, the adhesives cannot be completely dried, and black spots appear on the entire surface of the finished polarizer. In addition, it is verified that the orthogonal transmittance ratios as well are higher than 1.5, that is, the orthogonal properties are low.

While the present invention has been shown and described in connection with the exemplary embodiments, it will be apparent to those skilled in the art that modifications and variations can be made without departing from the spirit and scope of the invention as defined by the appended claims.

### DESCRIPTION OF REFERENCE NUMBERS

10, 110: POLARIZATION ELEMENT
20: ADHESIVE LAYER
30, 130: PROTECTIVE FILM
40: ADHESION LAYER
120: FIRST ADHESIVE LAYER
140: SECOND ADHESIVE LAYER
150: ADHESION LAYER
150a: FIRST ADHESION LAYER
150b: SECOND ADHESION LAYER

1. A polarizer, comprising:
a polarization element;
a first adhesive layer formed on one side of the polarization element;
a second adhesive layer formed on the other side of the polarization element;
a protective film attached to the first adhesive layer; and
an adhesion layer formed under the second adhesive layer.

2. The polarizer of claim 1, wherein each of the first and second adhesive layers has a thickness of 20 nm to 1,000 nm.

3. The polarizer of claim 1, wherein each of the first and second adhesive layers is formed of an adhesive material having a viscosity of 4 cP to 50 cP.

4. The polarizer of claim 1, wherein each of the first and second adhesive layers is formed of an adhesive material having a degree of polymerization of 500-1,800 and a solid content of 2-10% by weight.

5. The polarizer of claim 1, wherein each of the first and second adhesive layers is made of the same material.

6. The polarizer of claim 1, wherein each of the first and second adhesive layers comprises at least one selected from the group consisting of Poly Vinyl Alcohol-based resin, acryl-based resin, vinylacetate-based resin, and UV-curable adhesive resin.

7. The polarizer of claim 6, wherein each of the first and second adhesive layers is made of an adhesive resin comprising Poly Vinyl Alcohol-based resin having an acryl group and a hydroxyl group.

8. The polarizer of claim 7, wherein the Poly Vinyl Alcohol-based resin, having the acryl group and hydroxyl group comprising a repeating unit, is represented by a following chemical formula 1a and a repeating unit is represented by a following chemical formula 1b. 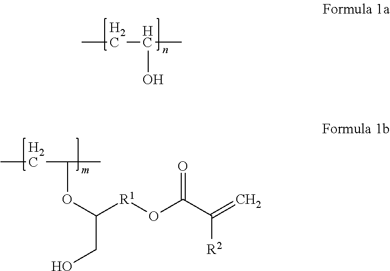
where,
n is an integer of 480 to 1,700, m is an integer of 10 to 900, n +m is an integer of 500 to 1,800;
R¹ may be substituted or unsubstituted C₁-C₂₀ alkandiyl; a substituted or unsubstituted 1 to 7-membered cyclic compound; a substituted or unsubstituted 1 to 7-membered hetero cyclic compound comprising hetero atoms selected from the group consisting of N, S, and O; a substituted or unsubstituted C₆-C₁₄ aromatic compound; or a substituted or unsubstituted 1 to 7-membered hetero aromatic compound comprising hetero atoms selected from the group consisting of N, S, and O; and
R² may be a substituted or unsubstituted C₁-C₂₀ alkyl group; a substituted or unsubstituted 1 to 7-membered cyclic compound; a substituted or unsubstituted 1 to 7-membered hetero cyclic compound comprising hetero atoms selected from the group consisting of N, S, and O; a substituted or unsubstituted C₆-C₁₄ aromatic compound; or a substituted or unsubstituted 1 to 7-membered hetero aromatic compound comprising hetero atoms selected from the group consisting of N, S, and O,
wherein, when said R¹ and R² are substituted with a substituent, the substituent may be a C₁ to C₂₀ alkyl group or a halogen atom selected from the group consisting of F, Cl, Br, and I.

9. The polarizer of claim 7, wherein the Poly Vinyl Alcohol-based resin containing the acryl group and hydroxyl group comprises a repeating unit represented by following chemical formula 1c. 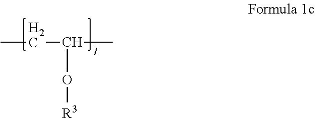
where,
n is an integer of 480 to 1,700, m is an integer of 10 to 900,1 is an integer of 1 to 80, n+m is an integer of 500 to 1,800, n +1 is an integer of 490-1,700, and n+m+1 is an integer of 500-1,800; and
R³ may be an acetoacetyl group, a carboxylic acid group, an acryl group, or a urethane group.)

10. The polarizer of claim 7, wherein the adhesive resin further comprises an initiator comprised of AIBN-based and persulphate-based water-soluble initiators.

11. The polarizer of claim 10, wherein the initiator is added in a maximal amount of 10% by weight based on a total weight of the adhesive resin.

12. The polarizer of claim 6, wherein each of the first adhesive layer and the second adhesive layer is comprised of an adhesive resin containing 100 parts by weight of Poly Vinyl Alcohol-based resin and 0.01 to 10 parts by weight of a compound having an epoxy group and an acryl group.

13. The polarizer of claim 12, wherein the compound having the epoxy group and the acryl group is represented by following chemical formula 3. 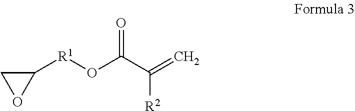
where,
R¹ is substituted or unsubstituted C₁-C₂₀ alkandiyl; a substituted or unsubstituted 1 to 7-membered cyclic compound; a substituted or unsubstituted 1 to 7-membered hetero cyclic compound comprising hetero atoms selected from the group consisting of N, S, and O; a substituted or unsubstituted C₆-C₁₄ aromatic compound; or a substituted or unsubstituted 1 to 7-membered hetero aromatic compound comprising hetero atoms selected from the group consisting of N, S, and O, and
R² may be a substituted or unsubstituted C₁-C₂₀ alkyl group; a substituted or unsubstituted 1 to 7-membered cyclic compound; a substituted or unsubstituted 1 to 7-membered hetero cyclic compound comprising hetero atoms selected from the group consisting of N, S, and O; a substituted or unsubstituted C₆-C₁₄ aromatic compound; or a substituted or unsubstituted 1 to 7-membered atom hetero aromatic compound comprising hetero atoms selected from the group consisting of N, S, and O,
wherein, when said R¹ and R² are substituted with substituent, the substituent may be C₁ to C₂₀ alkyl group or halogen atom selected from the group consisting of F, Cl, Br, and I.

14. The polarizer of claim 12, wherein the Poly Vinyl Alcohol-based resin has polymerization degree of 500 to 1,800.

15. The polarizer of claim 12, wherein the adhesive resin further comprises an initiator comprised of AIBN-based and persulphate-based water-soluble initiators.

16. The polarizer of claim 15, wherein the initiator is added in a maximal amount of 10% by weight based on a total weight of the adhesive resin.

17. The polarizer of claim 1, wherein the protective film is made of a polymer selected from the group consisting of polyester-type polymers, styrene-type polymers, cellulose-type polymers, polyethersulfone-type polymers, polycarbonate type polymers, acryl type polymers, polyolefin-type polymers, polyamide-type polymers, polyimide-type polymers, sulfone-type polymers, poly ether sulfone-type polymers, polyether ether ketone-type polymers, polyphenylene sulfide-type polymers, vinyl alcohol-type polymers, vinylidene chloride-type polymers, vinyl butyral-type polymers, arylate-type polymers, polyoxy methylene-type polymers, epoxy type-polymers, and mixtures thereof.

18. The polarizer of claim 1, wherein the adhesion layer comprises at least one selected from the group consisting of an acryl-type copolymer or an epoxy-type resin, a polyurethane-type resin, a silicon-type resin, a polyether-type resin, a polyamide-type resin and a Poly Vinyl Alcohol-based resin.

19. The polarizer of claim 1, wherein the adhesion layer is made of a first adhesion layer and a second adhesion layer having different moduli from each other.

20. The polarizer of claim 19, wherein the first adhesion layer has a modulus of 1-500 MPa, and the second adhesion layer has a modulus of 0.01-0.5 MPa.

21. The polarizer of claim 19, wherein the first adhesion layer is attached to the second adhesive layer.

22. An image display device comprising the polarizer of claim 1.

23. The image display device of claim 22, wherein the image display device is a liquid crystal display (LCD) device.

24. The image display device of claim 23, wherein the liquid crystal display device has an In-Plane Switching (IPS) driving mode, a Twisted Nematic (TN) driving mode, a Vertically Aligned (VA) driving mode, or a FFS (Fringe Field Switching) driving mode.

25. The image display device of claim 22, wherein the image display device is an organic electroluminescence (EL).

26. A method for manufacturing a polarizer, the method comprising:
positioning a protective film on one side of a polarization element, and positioning an adhesion layer on the other side of the polarization element;
interposing adhesives respectively between the protective film and the polarizer, and between the adhesion layer and the polarizer; and
laminating the protective film and the adhesion layer to the polarizer by the adhesives, and drying the resultant structure.

27. The method of claim 26, wherein the adhesive has viscosity of 4 cP to 50 cP.

28. The method of claim 26, wherein the adhesive has polymerization degree of 500-1,800 and solid content of 2-10% by weight.

29. The method of claim 26, wherein the drying is carried out at 20° C. to 100° C.
